(19) United States
(12) Patent Application Publication
(10) Pub. No.: US 2018/0107018 A1
(43) Pub. Date: Apr. 19, 2018

(54) INFLATABLE EYEGLASS

(71) Applicant: PROHERO GROUP CO., LTD., TAINAN CITY (TW)

(72) Inventor: PEN-WEI CHEN, TAINAN CITY (TW)

(21) Appl. No.: 15/296,265

(22) Filed: Oct. 18, 2016

(51) Int. Cl. G02C 5/00; G02C 5/14; G02C 5/12

(52) U.S. Cl. CPC G02C 5/008; G02C 5/143; G02C 5/126; G02C 5/14

(57) ABSTRACT

An inflatable eyeglass comprises a lens frame and two temples respectively pivoted to two sides of the lens frame. The lens frame, the temples or a soft pad at the temples is formed with a hollow chamber inside, which is filled with a gas. Therefore, the inflatable eyeglass can float on water, and the whole eyeglass is supported by the gas in the hollow chamber, effectively lightening the weight of the inflatable eyeglass to make the user feel comfortable while wearing the inflatable eyeglass.

### BACKGROUND OF THE INVENTION

### Field of the Invention

The present invention relates to an inflatable eyeglass. More particularly, the weight of the inflatable eyeglass is effectively lightened to make the user feel comfortable while wearing the inflatable eyeglass, achieving the lightweight effect.

### Description of Related Art

The eyeglass is an indispensable accessory for modern people. Such as sun glasses, working glasses, glasses for nearsighted individuals, hyperopia glasses, or reading glasses, all bring more convenience in people life.

However, the development of the eyeglass is until now, there are many inconvenient in use. For example, the oriental people usually have flat nose, the eyeglass with the general nose pad always falls off while the user wears the eyeglass, resulting in out of focus, the vision cannot be adjusted appropriately. Moreover, if the user uses the general eyeglass while exercise or sweating, the eyeglass is easier to falls off to be damaged. Or, the weight of the general eyeglasses is so heavy that the lateral sides of the user's nose is depressed to form concavity, affecting the appearance.

Accordingly, how to provide an eyeglass, which lightening weight and improving the use efficiency and product competitiveness, is an important issue now.

Therefore, the inventor provided an inflatable eyeglass, which the general structure and disadvantage are improved according to his experience in the development of the related industry, having more applicability.

### SUMMARY OF THE INVENTION

Therefore, the object of the present invention is related to an inflatable eyeglass. More particularly, the weight of the inflatable eyeglass is effectively lightened to make the user feel comfortable while wearing the inflatable eyeglass, achieving the lightweight effect.

For the above object, an inflatable eyeglass comprises a lens frame and two temples respectively pivoted to two sides of the lens frame. The lens frame, the temples or a soft pad at the temples is hollow, which is filled with a gas. Therefore, the inflatable eyeglass can float on water, and the whole eyeglass is supported by the gas in the hollow chamber, effectively lightening the weight of the inflatable eyeglass to make the user feel comfortable when wearing the inflatable eyeglass.

According to an embodiment of the present invention, the lens frame is formed with a hollow chamber filled with a gas

According to an embodiment of the present invention, each temple is formed with a hollow chamber filled with a gas.

According to an embodiment of the present invention, each temple is formed with a soft pad, and the soft pad is formed with a hollow chamber filled with a gas.

According to an embodiment of the present invention, the gas is filled to the lens frame, the temples, or the soft pad at the temples during an injection molding process.

According to an embodiment of the present invention, the gas is nitrogen.

Accordingly, the inflatable eyeglass of the present invention has the advantages as following:

1. Because the lens frame, the temples, or the soft pad at the temples is filled with the gas, the weight of the eyeglass is lightened, while the user wears the inflatable eyeglass of the present invention, the weight pressed on the user's ears and eyes is decreased, and the situation that the eyeglass is attached on the user is improved, making the user feel comfortable.

2. Because the lens frame, the temples, or the soft pad at the temples is filled with the gas inside, the inflatable eyeglass of the present invention can float on water for convenient searching.

3. Because the lens frame, the temples, or the soft pad at the temples is filled with the gas inside, the inflatable eyeglass of the present invention is lightweight design.

4. Because the lens frame, the temples, or the soft pad at the temples of the present invention is filled with the gas inside, the usage of plastic material is decreased effectively, achieving the effect of saving cost.

### BRIEF DESCRIPTION OF THE DRAWINGS

FIG. 1 is a schematic diagram of a lens frame of an inflatable eyeglass, which lens frame has single chamber, according to an embodiment of the present invention;

FIG. 2 is a schematic diagram of a lens frame of an inflatable eyeglass, which lens frame has several chambers according to an embodiment of the present invention;

FIG. 3 is a sectional view of a lens frame of an inflatable eyeglass according to an embodiment of the present invention;

FIG. 4 is a schematic diagram of the temple of an inflatable eyeglass, which temple has single chamber according to an embodiment of the present invention;

FIG. 5 is a schematic diagram of the temple of an inflatable eyeglass, which temple has several chambers according to an embodiment of the present invention; and

FIG. 6 is a schematic diagram of a soft pad at the temple of an inflatable eyeglass according to an embodiment of the present invention.

### DETAILED DESCRIPTION OF THE PREFERRED EMBODIMENT

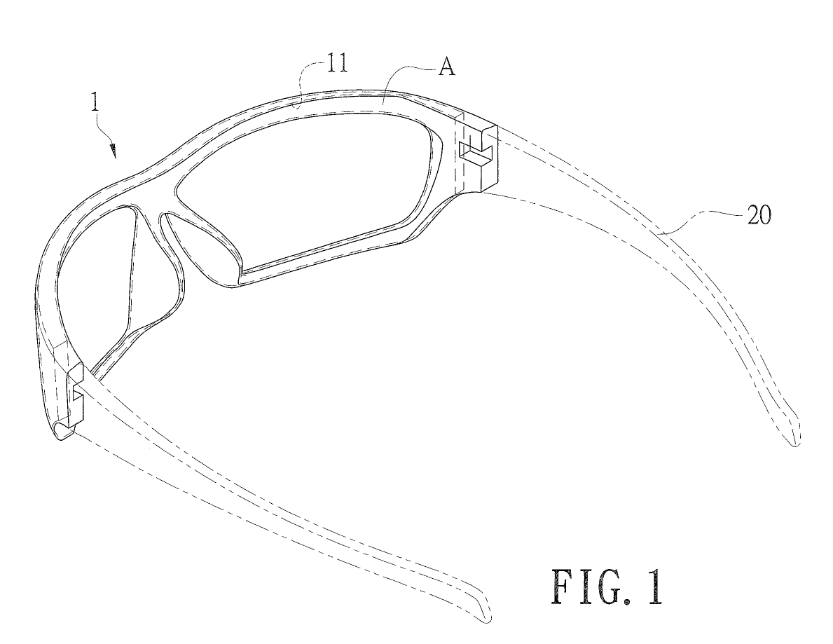

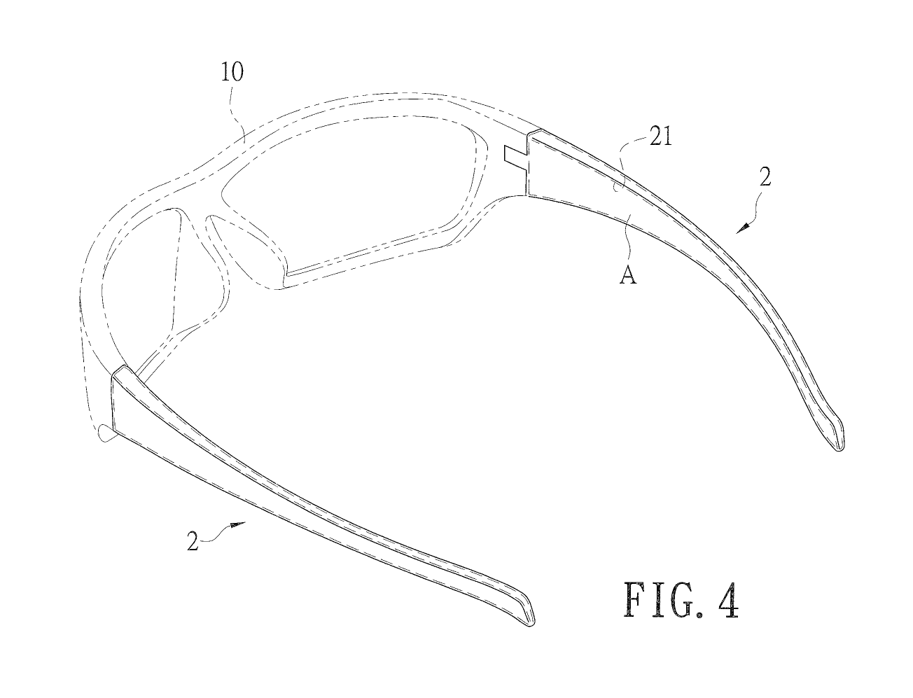

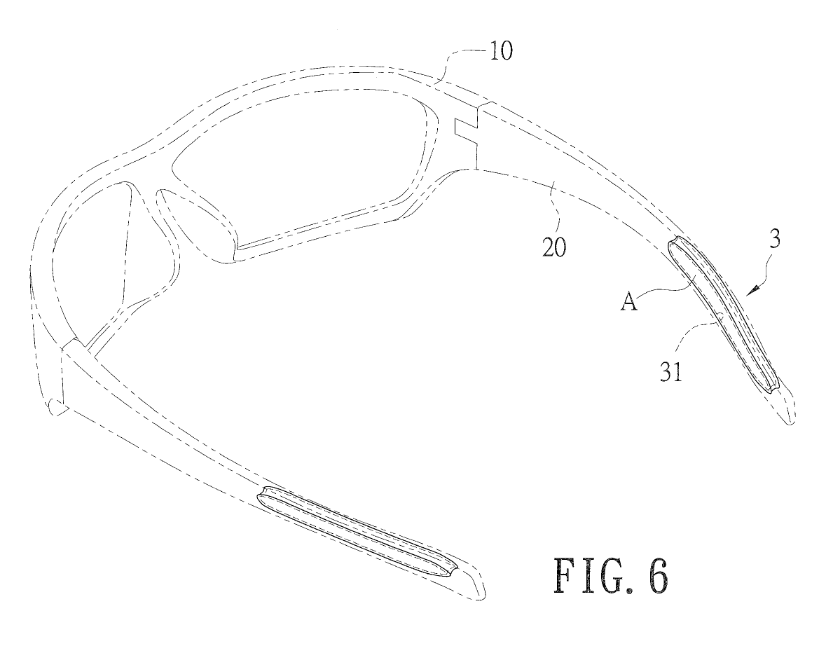

Please refer to FIG. 1, FIG. 4, and FIG. 6, which are schematic diagrams of an inflatable eyeglass according to an embodiment of the present invention. The inflatable eyeglass of the present invention comprises a lens frame 1 and right and left temples 2 respectively pivoted to two sides of the lens frame 1.

The inside of the lens frame 1 is formed with at least one first hollow chamber 11 filled with a gas A, and the gas A is filled to the first hollow chamber 11 during an injection molding process of the lens frame 1.

The inside of the each temple 2 is formed with at least one second hollow chamber 21 filled with a gas A, and the gas A is filled to the second hollow chamber 21 during an injection molding process of the temples 2.

The end of each temple 2 is formed with a soft pad 3 for protecting ears and anti-skid function, the inside of the soft pad 3 is formed with a third hollow chamber 31 filled with a gas A, and the gas A is filled to the third hollow chamber 31 during an injection molding process of the soft pad 3.

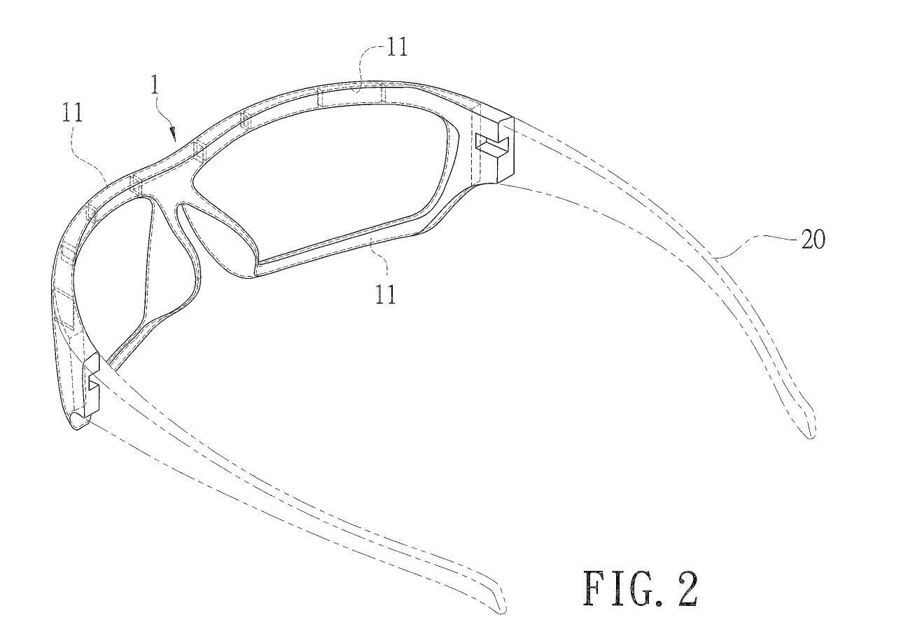

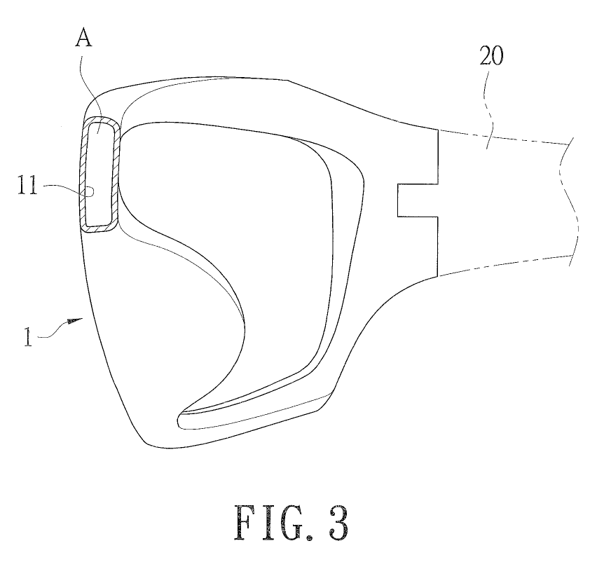

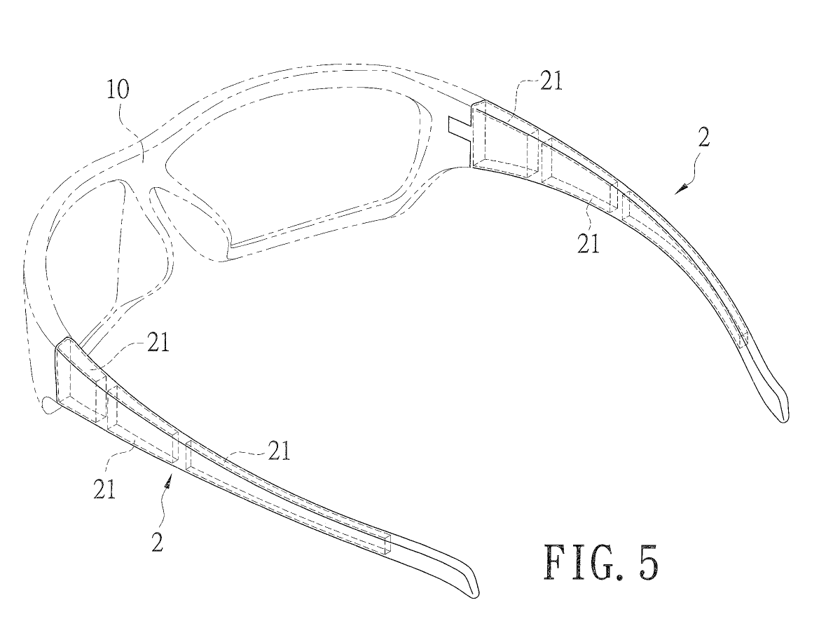

Please refer to FIG. 1 to FIG. 6. When actually using the inflatable eyeglass of the present invention, one of the lens frame 1, the temples 2, or the soft pad 3 at the temples 2 has the hollow chamber, or all of them have the hollow chamber. First, the embodiment of the lens frame 1 is described. As shown in FIG. 1, the inside of the lens frame 1 is formed with a first hollow chamber 11, in other words, the inside of the lens frame 1 is hollow. Or, the inside of the lens frame 1 is separated into several first hollow chambers 11. The foregoing first chamber 11 is filled with the gas A, and the solid temples 2 are pivoted to the two sides of the lens frame 1, lightening the weight of the inflatable eyeglass and achieving the lightweight design (shown as FIG. 1 to FIG. 3).

When the lens frame 10 is solid, the lightweight temples 2 are pivoted to the two sides of the solid lens frame 10. The embodiment of the temples 2 is described, shown as FIG. 4, the inside of the temples is formed with a second hollow chamber 21, in other words, the inside of the temples is hollow. Or, the inside of the temples 2 is separated into several second hollow chambers 21. The foregoing second chamber 21 is filled with the gas A, lightening the weight of the inflatable eyeglass and achieving the lightweight effect.

Please refer to FIG. 6. When the solid lens frame 10 and the solid temples 20 are used, the lightweight design is applied to the soft pad 3 at the solid temples 20. In other words, the end of the solid temples 20 has the soft pad 3, which has anti-skid function and the protection function for ears. The inside of the soft pad 3 is formed with a third hollow chamber 31, and the third hollow chamber 31 is filled with the gas A during an injection molding process of the soft pad 3, lightening the weight of the inflatable eyeglass and achieving the lightweight effect. The foregoing gas A filled into the hollow chamber is nitrogen with high stability.

The weight pressed on the user's nose and ears is decreased by the supporting force from the gas A, and the inflatable eyeglass of the present invention can float on the water while falling into water. Furthermore, while the user wears the inflatable eyeglass of the present invention, the user feels gentle touch and comfortable wearing due to the support of the gas A and the decreasing weight.

According to the above description and embodiments, the inflatable eyeglass of the present invention has the advantages as following:

1. Because the lens frame, the temples, or the soft pad at the temples is filled with the gas, the weight of the eyeglass is lightened, while the user wears the inflatable eyeglass of the present invention, the weight pressed on the user's ears and eyes is decreased, and the situation that the eyeglass is attached on the user is improved, making the user feel comfortable.

2. Because the lens frame, the temples, or the soft pad at the temples is filled with the gas inside, the inflatable eyeglass of the present invention can float on water for convenient searching.

3. Because the lens frame, the temples, or the soft pad at the temples is filled with the gas inside, the inflatable eyeglass of the present invention is lightweight design.

4. Because the lens frame, the temples, or the soft pad at the temples of the present invention is filled with the gas inside, the usage of plastic material is decreased effectively, achieving the effect of saving cost.

What is claimed is:

1. An inflatable eyeglass, comprising:
a lens frame, which inside formed with at least one first hollow chamber filled with a gas, wherein the gas is filled to the first hollow chamber during an injection molding process of the lens frame; and
right and left temples, respectively pivoted to two sides of the lens frame.

2. The inflatable eyeglass according to claim 1, wherein the gas is nitrogen.

3. An inflatable eyeglass, comprising:
a lens frame; and
right and left temples, respectively pivoted to two sides of the lens frame, wherein the inside of each temple is formed with at least one second hollow chamber filled with a gas, and the gas is filled to the second hollow chamber during an injection molding process of the temples.

4. The nose pad for eyeglass according to claim 3, wherein the gas is nitrogen.

5. An inflatable eyeglass, comprising:
a lens frame; and
right and left temples, respectively pivoted to two sides of the lens frame, wherein the end of each temple is formed with a soft pad for protecting ears and anti-skid function, the inside of the soft pad is formed with a third hollow chamber filled with a gas, and the gas is filled to the third hollow chamber during an injection molding process of the soft pad.

6. The inflatable eyeglass according to claim 5, wherein the gas is nitrogen.
